(19) United States
(12) Patent Application Publication
(10) Pub. No.: US 2025/0086959 A1
(43) Pub. Date: Mar. 13, 2025

(54) Method for Object and Key-point Detection and Host and Driver Monitoring System Thereof

(71) Applicant: AutoSys (TW) Co., Ltd., Hsinchu County (TW)

(72) Inventors: Jun-Yao Zhong, Hsinchu County (TW); Bo-Yu Chen, Hsinchu County (TW); Jui-Li Chen, Hsinchu County (TW); Tse-Min Chen, Hsinchu County (TW)

(21) Appl. No.: 18/776,573

(22) Filed: Jul. 18, 2024

(30) Foreign Application Priority Data
Sep. 13, 2023 (TW) 112134894

(51) Int. Cl. G06V 10/82; G06V 10/26; G06V 10/46; G06V 10/77; G06V 10/774; G06V 10/776; G06V 20/59

(52) U.S. Cl. CPC G06V 10/82; G06V 10/26; G06V 10/46; G06V 10/7715; G06V 10/776; G06V 20/597; G06V 10/774

(57) ABSTRACT

A method for object and key-point detection, comprising: receiving an image, executing a deep neural network architecture for the image to obtain one or more object bounding boxes; executing the deep neural network architecture for the one or more object bounding boxes to obtain one or more key-point positions corresponding to the one or more object bounding boxes; and outputting the one or more object bounding boxes and the one or more key-point positions.

This application claims priority to a Taiwan patent with application No. 112134894 and application date of Sep. 13, 2023.

### BACKGROUND OF THE INVENTION

### Field of the Invention

The present invention relates to the field of image detection and recognition technology, in particular to an object and key point detection method and its host and driver monitoring system.

### Description of Related Art

The driver image monitoring system is a system used to monitor and evaluate driver behavior. Its input is usually images captured by color photography wide-angle lenses. The pixels of the above images are usually encoded in three colors: red, green, and blue. Use neural-network-like images to detect the image and determine if the driver has violated regulations or lack of concentration.

In order to detect whether the driver holds distracting objects, such as a phone or cigarette, the aforementioned driver image monitoring system will perform more than one type of object detection. In addition, to detect whether the driver is focused, the above-mentioned driver image monitoring system will perform key point detection. The above key points can include the key points of facial and hand features. In short, the above-mentioned driver image monitoring system requires object detection function and key point detection function. Therefore, the above-mentioned driver image monitoring system requires two or more deep learning neural network models with different architectures to respectively achieve object detection and key point detection functions, thus requiring more than twice the judgment time.

In addition, due to the inability of ordinary visible light lenses to capture clear images in low light environments. In other words, the image lacks details for recognition. The class neural learning network model in deep learning cannot detect object features and key points features. In this case, in order to detect key points, the first neural model must be used to detect the position and size of the object to which the key points belong, and the detected object image must be cropped, followed by the second neural model to detect the position of each key point. When the first model detects N objects (where N is a positive integer), the second model must also perform N detections. These computing programs will cause significant time costs on the system, and will also incur significant time costs in post-processing. Due to the high speed of the vehicle, if it takes a long time to detect the driver's lack of concentration, there may not be enough time to issue a warning to the driver.

Based on this, there is an urgent need for a method that can reduce detection time and accelerate detection speed. Through a deep learning neural network model, key point detection tasks can be achieved without the need for the above two steps of judgment. That is to say, one of the above two steps can be omitted, achieving the dual function of object detection and key point detection through one step judgment.

### SUMMARY OF THE INVENTION

According to embodiments of the present invention, a detection method for objects and key points is provided, including: receiving an image; executing a deep neural network architecture based on the image to obtain one or more object bounding boxes; executing the deep neural network architecture based on one or more object bounding boxes to obtain the relative positions of one or more key points corresponding to the one or more object bounding boxes; as well as outputting the positions of one or more object bounding boxes and one or more key points.

Preferably, in order to provide images with more details under low light conditions, the image contains information in the infrared band.

Preferably, in order to utilize neural networks to implement deep neural network architectures, wherein the deep neural network architecture comprises: backbone architecture network; a neck network comprising a feature pyramid network and a pyramid attention network for extracting features from the backbone architecture network; as well as detect heads that obtain the positions of one or more object bounding boxes and one or more key points from the neck network.

Preferably, in order to identify objects and key points in shallow and deep information, the detect heads comprise a large object detect head, a medium object detect head, and a small object detect head, which are used to obtain the positions of one or more object bounding boxes and one or more key points from multiple blocks of different sizes in the neck network, respectively.

Preferably, in order to determine whether the object bounding box is trustworthy when executing a deep neural network architecture, the deep neural network architecture is trained based on multiple candidate samples and multiple benchmark real samples, and the threshold for determining whether the predicted box is the object bounding box corresponds to the average and square difference of the multiple candidate samples and their corresponding benchmark real samples.

Preferably, in order to train the object detection performance of deep neural network architecture, the object box regression Distance Intersection Over Union loss function of the deep neural network architecture is related to the following two: the threshold; as well as the ratio of multiple intersection to union sets of multiple candidate samples and their corresponding multiple benchmark real samples.

Preferably, in order to train the object key point detection performance of deep neural network architecture, the key point loss function of the deep neural network architecture is a wing loss function.

Preferably, in order to enhance the key point detection performance of deep neural network architecture, the deep neural network architecture evaluates the performance of object key point detection during training using one or any combination of the following algorithms: Object Key-Point similarity (OKS) algorithm; as well as Percentage of Correct Key-points (PCK) algorithm.

Preferably, in order for the deep neural network architecture to provide driver status within a vehicle (such as a car), the one or more object bounding boxes and their corresponding one or more key points correspond to one or any combination of the following categories of objects: face, hand, mobile phone, cigarette, glasses, and seat belt.

An embodiment of the present invention provides a host for objects and key points detection, comprising one or more processors for executing multiple computer instructions stored in non-volatile memory to implement the detection method for objects and key points.

An embodiment of the present invention provides a driver monitoring system for objects and key points detection, comprising: the host set within the vehicle; as well as a photography device for providing the image.

### Beneficial Effects

In summary, the objects and key points detection method provided by the present invention, as well as its host and driver monitoring system, can achieve dual functions of object detection and key point detection through one-step judgment, reduce post-processing time, solve problems caused by environmental and light changes, achieve less processing and calculation requirements, reduce calculation time, and improve the real-time performance of the driver monitoring system.

### BRIEF DESCRIPTION OF THE FIGURES

FIGS. 1 and 2 are schematic diagrams of the deep neural network architecture 100 of an embodiment of the present invention.

FIG. 3 is an image schematic diagram of an adaptive training sample selection program in an embodiment of the present invention.

FIG. 4 is a schematic diagram of the distance between the predicted box and the realistic box of the present invention.

FIG. 5 is a schematic diagram of the intersection and union of two boxes.

FIG. 6 is a schematic diagram of the LUT (Look Up Table) of the loss function in an embodiment of the present invention.

FIGS. 7A and 7B respectively illustrate the results of object detection and key point detection based on the deep neural network architecture 100 provided by the present invention.

FIG. 8 is a block diagram of a driver monitoring system 800 in an embodiment of the present invention.

FIG. 9 is a flowchart illustrating the object and key point detection method 900 of an embodiment of the present invention.

### EXPLANATION OF ATTACHED IMAGE MARKINGS

100: Deep neural network architecture; 110: Input image; 120: Backbone architecture network; 130: Neck network; 140: Detect head; 141: Large object detect head; 142: Medium object detect head; 143: Small object detect head; 150: Output image.
410: Predicted box; 420: Realistic box; 430: Minimum closure region or minimum union rectangle region.
800: Driver monitoring system; 810: Host; 811: Processor; 812: Co-processors; 813: Peripheral device connection device; 814: Storage device; 820: Photography equipment.
900: Object and key point detection methods; 910-940: Steps.

### DETAILED DESCRIPTION OF THE INVENTION

In order to make the purpose, technical solution, and advantages of the present invention clearer, a detailed description of the technical solution of the present invention will be provided below. Obviously, the described embodiments are only a part of the present invention and not a comprehensive set of embodiments. On the basis of the embodiments of the present invention, all other embodiments obtained by ordinary technicians in the art without creative labor fall within the scope of protection of the present invention.

The terms “first,” “second,” and “third” (if any) in the specification, claims, and drawings of a patent application are used to distinguish similar objects and do not need to be used to describe a specific order or sequence. It should be understood that the described objects can be interchanged in appropriate circumstances. In the specification of the present invention, “plural” refers to two or more, unless otherwise specifically limited. In addition, the terms “including (or compromising)” and “having” and any variations thereof are intended to encompass non exclusivity. Some of the block diagrams shown in the attached diagram are functional entities and may not necessarily correspond to physically or logically independent entities. These functional entities can be implemented in software form, or in one or more hardware circuits or integrated circuits, or in different networks and/or processor devices and/or microcontroller devices.

In the description of the present invention, it should be noted that unless otherwise specified and limited, the terms “installation”, “connection”, and “connection” should be widely understood, for example, they may be fixed connections, detachable connections, or integrated connections; It can be mechanically connected, electrically connected, or communicate with each other; It can be directly connected or indirectly connected through an intermediate medium, which can be two components connected internally or have an interaction relationship between the two components. For ordinary technical personnel in this field, the specific meanings of the above terms in the present invention can be understood according to specific circumstances.

In order to make the purpose, features, and advantages of the present invention more obvious and easy to understand, the following will provide further detailed explanations of the present invention in conjunction with the schematic diagram and specific implementation methods.

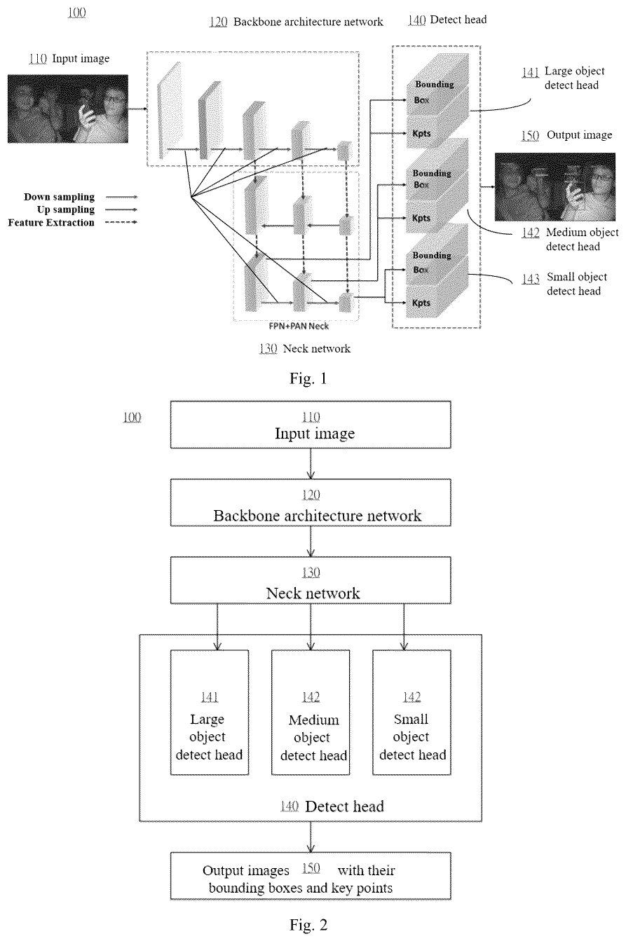

Please refer to FIGS. 1 and 2, which are schematic diagrams of the deep neural network architecture 100 of an embodiment of the present invention. This deep neural network architecture 100 is a single architecture used for integrating object detection and key point detection, which can simultaneously achieve two different types of detection and recognition: object detection and key point detection. The deep neural network architecture 100 is based on the object detection architecture, but extends to the functionality of key point detection. The difference from previous techniques is that the previous key point detection used the absolute position of the entire image for prediction, while the deep neural network architecture 100 used object box center point regression to calculate the relative position of each key point.

In one application of the present invention, it is applicable to a driver monitoring system. The above deep neural network architecture 100 is used to detect objects containing faces, hands, mobile phones, cigarettes, glasses, and/or seat belts, as well as identify key points of the aforementioned types of objects. Ordinary technical personnel in this field can understand that although the present invention can be applied to driver monitoring systems, it can also be applied to embodiments of object recognition and key point recognition for other objects. For example, in certain surgeries, the deep neural network architecture 100 provided in the present invention can be used to detect certain organs, surgical instruments, cotton and other objects, as well as detect key points of certain organs and surgical instruments. In the implementation of image recognition in missile guidance heads, the deep neural network architecture 100 provided by the present invention can be used to detect objects such as tanks, armored vehicles, or other tactical vehicles, and to detect key points of weaknesses such as the top cover of certain tanks.

As shown in FIGS. 1 and 2, the deep neural network architecture 100 includes a three-layer network architecture, where the image 110 is input into the backbone network 120, followed by multiple down-sampling operations, input into the neck network 130 for feature extraction, and ultimately output to the detect head 140. The detect head 140 outputs detection results such as bounding boxes and key points of the object. These detection results can be superimposed on the original input image 110 to form an output image 150.

In one embodiment, the aforementioned backbone network 120 may include one of the following or its derivatives: Darknet53, DenseNet, CSPDenseNet (Cross Stage Partial Dense Network), etc., for accelerating and parallel computing.

In one embodiment, the aforementioned neck network 130 may include a network of Feature Pyramid Network (FPN) and Pyramid Attention Network (PAN), enabling the exchange of deep and shallow information in the architecture. In another embodiment, the aforementioned neck network 130 can combine two models: Spatial Pyramid Pooling Layer (SPP) and Path Aggregation Network (PANet).

The above detect head 140 can detect objects. In the present invention, the detect head 140 adds a key point detection branch to output detection results with object bounding boxes and key points. Ordinary technical personnel in this field can understand that the above-mentioned backbone network 120 and neck network 130 can be implemented using other types of deep neural networks, as long as they can enable subsequent detect heads 140 to obtain detection results of bounding boxes and key points of large, medium, and small objects.

As shown in FIGS. 1 and 2, the detect head 140 may include three different branches, each of which detects large, medium, and small objects based on different orders of the pyramids in the neck network 130. In each detect head 141, 142, and 143, the image is divided into multiple blocks, each with multiple reference boxes (anchors). The detect heads 141, 142, and 143 can predict the offset of the target object relative to the reference box. Each reference box can predict one or more bounding boxes, and finally, the less likely bounding boxes are eliminated based on the trust index.

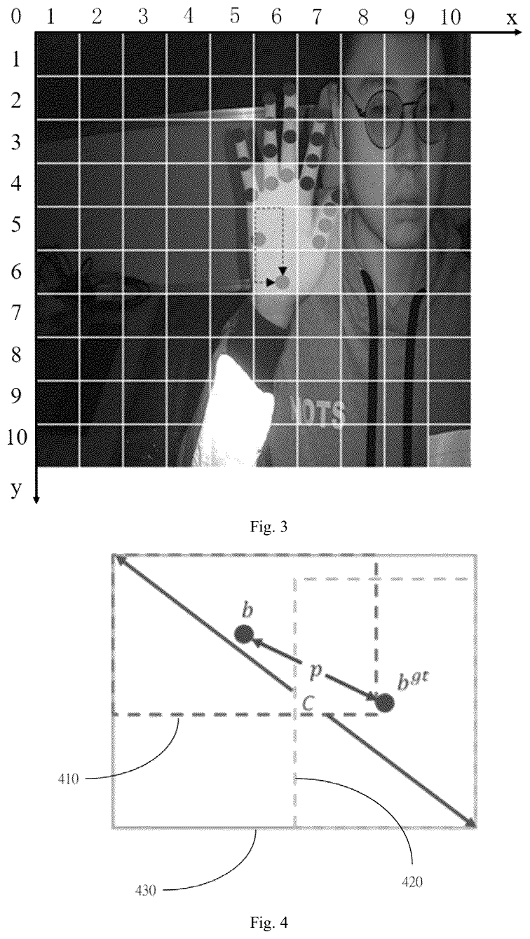

When training the detect head 140, it is necessary to first preprocess the training data. In one embodiment, an adaptive training sample selection (ATSS) program can be used to calculate the position of positive samples of the object to be detected. Please refer to FIG. 3, which is an image schematic diagram of the adaptive training sample selection program provided in an embodiment of the present invention. The image shown in FIG. 3 is divided into multiple rectangular blocks (units). The size of the block is determined by the input image 110 of the deep neural network architecture 100 and the number of down-sampling times. When the input image 110 of the deep neural network architecture 100 is 320*320 pixels and undergoes five down-sampling, the size of each rectangular block is 10*10 pixels. The output size of the detect head shown in FIG. 3 is [n, h*w, c], wherein h is the height of the matrix in the block matrix, w is the width of the matrix in the storage block matrix, h*w is the number of blocks, c represents the number of key points, and n represents the number of channels in the deep neural network architecture 100.

Please refer to Table 1, which is the calculation formula used to determine the positive and negative sample thresholds in the adaptive training sample selection program mentioned above. Table 1 contains three equations, and equation (1) is used to calculate the average or mean value u between the candidate samples and the ground true samples. Equation (2) is used to calculate the variance or squared difference σ between the candidate sample and the ground true sample. Equation (3) is used to calculate the threshold IoU for positive and negative samples, which is the sum of the average or mean value μ obtained from equation (1) and the variance or square difference σ obtained from equation (2). In one embodiment, the IoU Threshold used to determine positive and negative samples may be related to the average or mean μ and variance or squared difference σ, for example, the IoU Threshold may be directly proportional to the average or mean μ. The IoU Threshold can also be directly proportional to variance or squared difference σ.

TABLE 1
Threshold Calculation for object Sampling in Adaptive Training Sample
Selection Program

| | |
|---|---|
| $μ = \frac{{\sum }_{i = 1}^{N} {x}_{\dot{i}}}{N}$ | (1) |
| $σ = \sqrt{\frac{{\sum }_{i = 1}^{N} {( {x}_{i} - μ )}^{2}}{N}}$ | (2) |
| $IoU Threshold = μ + σ$ | (3) |

As shown in FIG. 3, the light gray block represents the positive sample block. The light gray block is the block composed of coordinates (6, 4), (6, 5), (6, 6), (7, 5), and (7, 6). The representation of coordinates is (x, y). Next, based on the reference coordinates of the rectangular block, calculate the relative position or relative coordinates of each key point with the above reference coordinates. In one embodiment, the reference coordinates of the rectangular block mentioned above typically refer to the coordinates of one of the four corners, such as the upper left corner. As shown in FIG. 3, the relative position or coordinates between the bottom key point (coordinates (6, 6)) and the block can be calculated. As mentioned earlier, this is one of the differences between the present invention and prior art.

The loss functions used in the deep neural network architecture 100 are shown in Table 2:

TABLE 2
Loss Functions for Object and Key Point Detection

| | |
|---|---|
| $GFL ( {p}_{y l} , {p}_{y r} ) = QFL ( {p}_{y l} ) + DFL ( {p}_{y l} , {p}_{y r} )$ | (4) |
| $DIOU = IOU - \frac{{p}^{2} ( b , {b}^{gt} )}{{c}^{2}}$ | (5) |
| $wing loss ( pt , gt ) = LUT ( D ( pt , gt ) )$ | (6) |

Table 2 contains three equations. Equation (4) is used to calculate the generalized Focal Loss (GFL) for object detection, which is the sum of the QFL (Quality Focal Loss) and the DFL (Distribution Focal Loss) for object bounding box regression for category confidence. Among them, p_{yl} represents the detection result, and p_{yr} is the true result. In one embodiment, the loss function GFL used for calculating object detection may be related to QFL and DFL, but may not necessarily be an additive relationship. For example, the loss function GFL can be directly proportional to QFL. The loss function GFL can also be directly proportional to DFL. To explain it in a physical way, it is assumed that the deep neural network architecture 100 is a shooter and the predicted object position is the position of the target center during shooting. The farther the arrow position is from the target center, the more values will be lost, and vice versa, the less values will be lost.

Please refer to FIG. 4, which is a schematic diagram of the distance between the predicted box and the realistic box of the present invention. FIG. 4 shows the predicted box 410 in the upper left corner, the realistic box 420 in the lower right corner, and the minimum closure region or minimum union rectangle region 430 of both. The predicted box 410 has a center point b. The realistic box 420 has a center point b^{gt}. P is the Euclidean distance between these two center points. C represents the diagonal distance of the minimum closure region 430 that can simultaneously contain both the predicted box 410 and the realistic box 420.

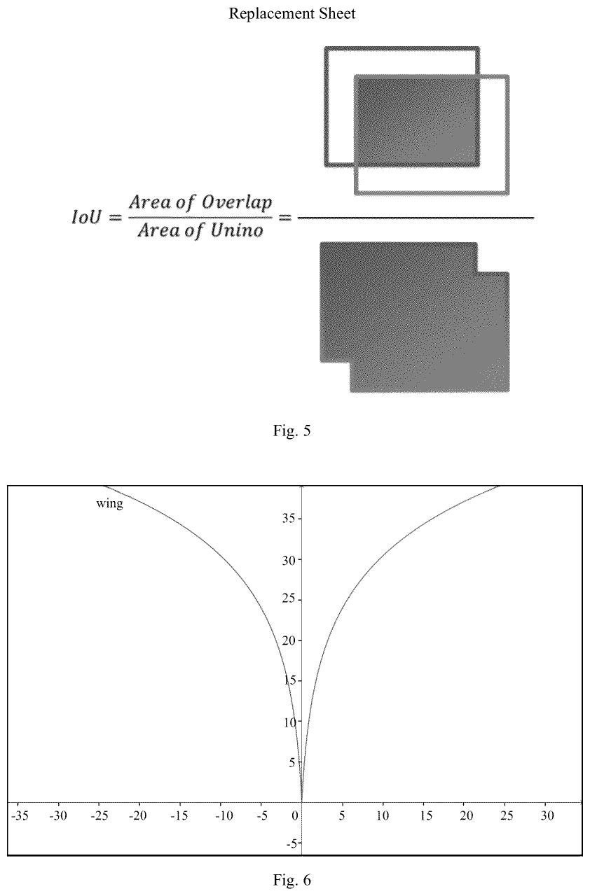

Based on the above parameters, equation (5) can be used to calculate the object box regression loss function (DIOU, Distance IOU loss). The loss function of object box regression is related to the ratio of intersection over union (IoU). Please refer to FIG. 5, which is a schematic diagram of the intersection and union of two boxes. The predicted box 410 and the realistic box 420 in FIG. 4 can be considered as the two boxes in FIG. 5. When the intersection above the graph and the union below the graph become more consistent, it indicates that the predicted box 410 is closer to the realistic box 420. When the intersection above the graph is equal to the union below the graph, that is, when the ratio of intersection to union IoU is 1, it indicates that the predicted box 410 is equivalent to the realistic box 420. Please refer to equation (7) in Table 3, which is the calculation method for the ratio of intersection to union.

TABLE 3
The calculation method for the ratio of intersection to union

| | |
|---|---|
| $IoU = \frac{\vert A ⋂ B \vert}{\vert A ⋃ B \vert} = \frac{\vert A ⋂ B \vert}{\vert A \vert + \vert B \vert - \vert A ⋃ B \vert}$ | (7) |

The subtraction shown in equation (5) is the ratio of the squared Euclidean distance b² between the center of predicted box 410 and the center of realistic box 420 to the diagonal distance c². Similarly, the closer the predicted box 410 is to the realistic box 420, the closer this ratio will be to 0. In other words, the regression loss function of the object box is closer to 1. To explain it in a physical way, the farther the target box predicted by the deep neural network architecture 100 is from the realistic box, the more values are lost; Otherwise, the fewer values will be lost. In one embodiment, the object box regression loss function DIOU can be directly proportional to the ratio IoU of intersection to union. In one embodiment, the object box regression loss function DIOU can be inversely proportional to the subtraction of equation (5). In one embodiment, the object box regression loss function DIOU can be inversely proportional to the square b² of the Euclidean distance between the center of the predicted box 410 and the center of the realistic box 420.

Equation (6) shows the Wing loss function for key point detection. Please refer to FIG. 6, which is a schematic diagram of the LUT (Look Up Table) of the loss function in one embodiment of the present invention. Due to its shape resembling unfolded wings, this loss function is called the wing loss function. The input value of the loss function is the difference or distance value between the detected key point pt and the realistic point gt. By substituting the difference into the lookup table, the error value can be obtained. Physically speaking, the greater the distance difference between the two, the more values will be lost. On the contrary, the less value is lost. In one embodiment, the above loss function may be a quadratic function.

When training the deep neural network architecture 100, the performance of object detection and key point detection can be evaluated separately. The performance evaluation of object detection can be calculated using the above FIG. 5 and Equation (7). When the predicted box 410 overlaps with the realistic box 420, the ratio becomes closer to 1.

For the performance evaluation of key point detection, the Object Key point Similarity (OKS) algorithm can be used. The accuracy of key point detection can be measured by comparing the distance between the predicted key point position and the actual key point position, similar to the distance function D in equation (6). It is a similarity measure based on Euclidean geometric distance. Consider the size of actual key points and the importance of corresponding parts, with each key point information including key point coordinates and score values. This score value can be used to indicate the visibility or confidence of key points. When evaluating, the prediction results are usually filtered based on the weighted scores of key points, retaining the key points with higher scores.

Please refer to equation (8) in Table 4, which is the Object Key point Similarity (OKS) algorithm mentioned above. Among them, dp represents the Euclidean distance, Sp represents the scale factor of the current object, which is the square root of the area occupied by the key point object in the real object, and σ represents the normalization factor of the key point, wherein the normalization factor is the standard deviation calculated based on the Ground True samples in all datasets, reflecting the degree of influence of the key point on the whole. The larger the value of the normalization factor, the worse the annotation effect on key points in the entire dataset. On the contrary, the smaller the value of the normalization factor, the better the annotation effect on key points in the entire dataset. vₚi=1 indicates that the score or visibility of the key point is 1. Δ is the selection function used to select visible key points for calculation.

TABLE 4
Evaluation Formula for Object Key point Similarity

| | |
|---|---|
| ${OKS}_{p} = \frac{{\sum }_{i} exp \{ - {d}_{{p}^{2}}^{2} / 2 {S}_{p}^{2} {σ}_{i}^{2} \} ( {v}_{{p}^{i}} = 1 )}{{\sum }_{i} δ ( {v}_{{p}^{i}} = 1 )}$ | (8) |

Match real key points with predicted key points and calculate the Euclidean distance between each matched key point. Then, based on the Euclidean distance dp, the square root Sp of the area occupied by the keypoint object in the real object, the standard deviation normalization factor, and the score value mentioned above, calculate the similarity measure OKSₚ. The range of similarity measure OKSₚ is between 0 and 1, and the closer it is to 1, the higher the match between the predicted and actual results.

Another algorithm used to evaluate the performance of key point detection models is the PCK (Percentage of Correct Key points) algorithm. Similarly, comparing the Euclidean distance between the predicted key points of the deep neural network architecture 100 and the actual annotated key points, if the distance between the two points is less than a certain threshold, it is considered a correct prediction. The threshold can be a proportional value of the actual length or width. The proportion of correct key points mentioned above is the percentage of correctly predicted key points. Please refer to equation (9) in Table 5, which is the evaluation formula for the correct proportion of key points.

TABLE 5
The evaluation formula for the Percentage of Correct Key points

| | |
|---|---|
| $PCK = \frac{1}{N} {\sum }_{i = 1}^{N} 1 ( {‖ {p}_{i} - {g}_{i} ‖}_{{2}^{}} \leq α \cdot s )$ | (9) |

As shown in equation (9), N is the number of key points, pᵢ is the position of the i-th predicted key point, gᵢ is the position of the i-th true annotated key point, ∥ ∥₂ represents the Euclidean distance, and 1 ( ) is an indicator or conditional function. When the condition in parentheses is true, the function value is 1, otherwise it is 0. As mentioned earlier, a can be a proportional value of the true length or width, such as 0.1, 0.15, or 0.2. S is a reference scale, such as the length of an object, such as the size of the head or the length of the palm.

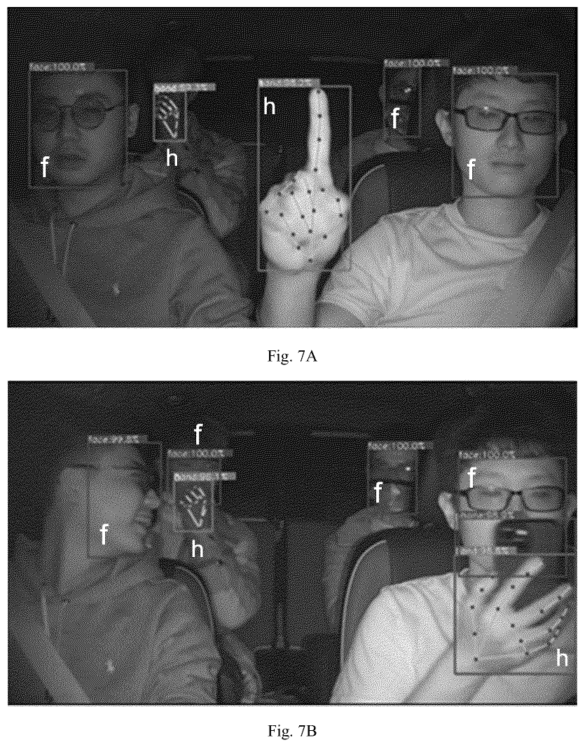

Please refer to FIGS. 7A and 7B, which are schematic diagrams of object detection and key point detection results based on the deep neural network architecture 100 provided in the present invention. In these two result graphs, two categories of objects can be detected. The “h” frame shows the hands, and the “f” frame shows the face. In addition, multiple key points were detected in the hand frame, representing various joints of the hand. In other words, the deep neural network architecture 100 provided by the present invention can also provide information about object categories.

The advantage of the deep neural network architecture 100 provided by the present invention is that object detection and key point detection can be achieved with a single model for a single judgment. Please refer to Table 6 below. Compared with previous techniques, the present invention significantly reduces the judgment time, while the accuracy only slightly decreases. After conversion, the overall cost-effectiveness is as high as 269 times, which indeed reduces the computational cost and time of judgment without affecting detection accuracy.

TABLE 6
Comparison between the present invention
and previous technologies

| | Deep | Previous | |
|---|---|---|---|
| | Neural | technol- | |
| | Network | ogies | Difference |
| Judging time | 28 ms | 47 ms | Reduce 40.4% |
| Object detection accuracy | 0.940 | 0.948 | Decreased by 0.8% |
| Key point detection | 0.853 | 0.848 | Increase by 0.5% |
| accuracy | | | |

| | |
|---|---|
| Determine the proportion of time | (40.4/((0.8 − 0.5)/ |
| reduction/accuracy decrease | 2)) = 269 |

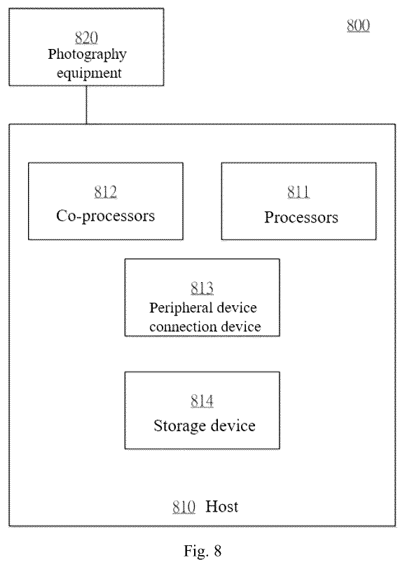

Please refer to FIG. 8, which is a block diagram of the driver monitoring system 800 in an embodiment of the present invention. The driver monitoring system 800 can be implemented within a vehicle, which can be a mobile device that requires driver operation, such as cars, ships, submarines, aerospace equipment, etc. The vehicle can also include any mechanical driver's seat, such as the driver's seat of a crane. The above deep neural network architecture 100 can be implemented in host 810. The host 810 includes at least one processor 811 for executing an operating system to control the host 810 and/or driver monitoring system 800. Processor 811 can be an x86, x64, ARM, RISC-V, or other industry standard instruction set processor. The operating system can be a UNIX series, Windows series, Android series, iOS series, or other series of operating systems, or it can be an instant operating system.

Host 810 may include one or more co-processors 812 to accelerate the judgment of deep neural network architecture 100. One or more co-processors 812 may be graphics processing units (GPUs), neural network processing units (NPUs), artificial intelligence processing units (APUs), and other processors with multiple vector logic and computing units, used to accelerate the judgment of deep neural network architecture 100. The present invention does not limit that the host 810 must have a co-processor 812 to achieve the determination of deep neural network architecture 100.

The host 810 also includes a peripheral device connection device 813, which can be used to connect one or more photography devices 820. The host 810 may also include a storage device 814 for storing the aforementioned operating system and implementing programs for deep neural network architecture 100. Ordinary technical personnel in this field need to have knowledge of computer organization and architecture, operating systems, system programs, artificial intelligence, and deep neural networks. They can modify or derive embodiments of the aforementioned host 810 and driver monitoring system 800, but as long as the deep neural network architecture 100 provided in the present invention can be implemented.

The photography device 820 can be connected to the peripheral device connection device of the host 810 through an industrial standard interface, such as common wired or wireless connection technologies such as UWB, WiFi, Bluetooth, USB, IEEE 1394, UART, iSCSIs, PCI-E, SATA, and other industrial standard technologies. The present invention is not limited to the above-mentioned industrial standard interfaces, as long as the speed of the image provided by the photography device 820 can meet the real-time requirements of the driver monitoring system 800.

The photography equipment 820 can include sensors in the traditional visible light band as well as sensors in the infrared band. Under low light conditions, the photography device 820 may also include an infrared light source for illuminating the driver's seat to be monitored, ensuring that the photography device 820 can output images with sufficient details for processing by the deep neural network architecture 100.

In one embodiment, the peripheral device connection device 813 may output the results of the deep neural network architecture 100 judgment to other devices or systems. The judgment of the deep neural network architecture 100 above includes more than one object bounding box and its associated key point positions. For example, the judgment results can be output to storage devices in order to identify certain key objects during playback of monitoring images. For example, when replaying surveillance footage, it is possible to search for object bounding boxes with cigarettes and faces, as well as images of cigarette filter key points close to human mouth key points, in order to determine whether the driver or passenger is smoking. In another embodiment, search for bounding boxes of objects with mobile phones and faces, as well as images of the key points of the mobile phone close to the key points of the human mouth, in order to determine whether the driver or passenger is making a phone call.

In another embodiment, the host 810 may execute other programs to receive the judgment results of the deep neural network architecture 100. For example, when the judgment result meets certain conditions, a warning program can be executed to alert other peripheral devices to the driver.

In further embodiments, the host 810 can send the judgment result to the driving control system of the vehicle through the peripheral device connection device 813, and the driving control system can determine whether to switch to the mode of the autonomous driving control program. For example, when the key points of the driver's hands are detected leaving the steering wheel, the driving control system can temporarily switch to the fourth or fifth level autonomous driving mode. In other words, in the present invention, the host 810 can output the judgment results of the deep neural network architecture 100, or output information derived from the judgment results of the deep neural network architecture 100.

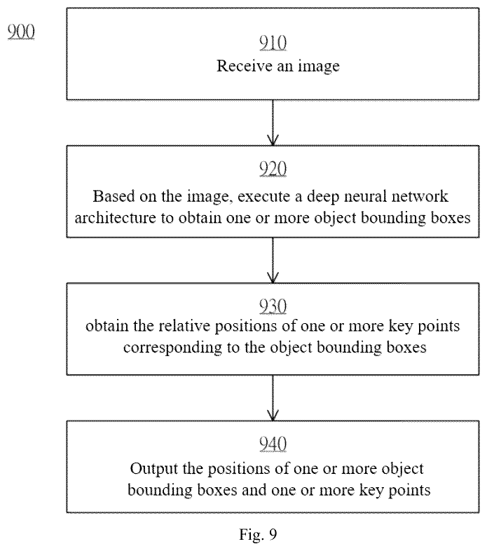

Please refer to FIG. 9, which is a flowchart of the object and key point detection method 900 provided in an embodiment of the present invention. The object and key point detection method 900 can be implemented based on the deep neural network architecture 100, particularly by computer instructions executed by the host 810 shown in FIG. 8. The object and key point detection method 900 can start from step 910.

Step 910: Receive an image. As shown in FIG. 8, the host 810 can receive an image from the photography device 820. Next, the process proceeds to step 920.

Step 920: Based on the image, execute a deep neural network architecture (such as deep neural network architecture 100) to obtain one or more object bounding boxes. Next, the process enters step 930.

Step 930: Execute a deep neural network architecture based on one or more object bounding boxes to obtain the relative positions of one or more key points corresponding to the object bounding boxes. It is worth noting that the relative position of one or more key points corresponds to the center or corner position of their object bounding boxes, rather than the position of the image. Based on this, it can be inferred that the deep neural network architecture 100 provided in the present invention identifies objects and key points in the detection head through one judgment rather than two judgments. Next, the process enters optional step 940.

Optional step 940: Output the positions of one or more object bounding boxes and one or more key points mentioned above. In this step, the position of the above key points can be the relative position obtained in step 930, or the position of the key points relative to the image calculated by the corresponding object bounding box.

An embodiment of the present invention provides a detection method for objects and key points, including: receiving an image; executing a deep neural network architecture based on the image to obtain one or more object bounding boxes; executing the deep neural network architecture based on one or more object bounding boxes to obtain the relative positions of one or more key points corresponding to the one or more object bounding boxes; as well as outputting the positions of one or more object bounding boxes and one or more key points.

Preferably, in order to provide images with more details under low light conditions, the image contains information in the infrared band.

Preferably, in order to utilize neural networks to implement deep neural network architectures, wherein the deep neural network architecture comprises: backbone architecture network; a neck network comprising a feature pyramid network and a pyramid attention network for extracting features from the backbone architecture network; as well as detect heads that obtain the positions of one or more object bounding boxes and one or more key points from the neck network.

Preferably, in order to identify objects and key points in shallow and deep information, the detect heads comprise a large object detect head, a medium object detect head, and a small object detect head, which are used to obtain the positions of one or more object bounding boxes and one or more key points from multiple blocks of different sizes in the neck network, respectively.

Preferably, in order to determine whether the object bounding box is trustworthy when executing a deep neural network architecture, the deep neural network architecture is trained based on multiple candidate samples and multiple benchmark real samples, and the threshold for determining whether the predicted box is the object bounding box corresponds to the average and square difference of the multiple candidate samples and their corresponding benchmark real samples.

Preferably, in order to train the object detection performance of deep neural network architecture, the object box regression Distance Intersection Over Union loss function of the deep neural network architecture is related to the following two: the threshold; as well as the ratio of multiple intersection to union sets of multiple candidate samples and their corresponding multiple benchmark real samples.

Preferably, in order to train the object key point detection performance of deep neural network architecture, the key point loss function of the deep neural network architecture is a wing loss function.

Preferably, in order to enhance the key point detection performance of deep neural network architecture, the deep neural network architecture evaluates the performance of object key point detection during training using one or any combination of the following algorithms: Object Key-Point similarity (OKS) algorithm; as well as Percentage of Correct Key-points (PCK) algorithm.

Preferably, in order for the deep neural network architecture to provide driver status within a vehicle (such as a car), the one or more object bounding boxes and their corresponding one or more key points correspond to one or any combination of the following categories of objects: face, hand, mobile phone, cigarette, glasses, and seat belt.

An embodiment of the present invention provides a host for objects and key points detection, comprising one or more processors for executing multiple computer instructions stored in non-volatile memory to implement the detection method for objects and key points.

An embodiment of the present invention provides a driver monitoring system for objects and key points detection, comprising: the host set within the vehicle; as well as a photography device for providing the image.

In summary, the objects and key points detection method provided by the present invention, as well as its host and driver monitoring system, can achieve dual functions of object detection and key point detection through one-step judgment, reduce post-processing time, solve problems caused by environmental and light changes, achieve less processing and calculation requirements, reduce calculation time, and improve the real-time performance of the driver monitoring system.

What is claimed is:

1. A detection method for objects and key points, including:
Receiving an image;
Executing a deep neural network architecture based on the image to obtain one or more object bounding boxes;
Executing the deep neural network architecture based on one or more object bounding boxes to obtain the relative positions of one or more key points corresponding to the one or more object bounding boxes; as well as
Outputting the positions of one or more object bounding boxes and one or more key points.

2. The detection method for the objects and key points according to claim 1, wherein the image contains information in the infrared band.

3. The detection method for objects and key points according to claim 1, wherein the deep neural network architecture comprises:
Backbone architecture network;
A neck network comprising a feature pyramid network and a pyramid attention network for extracting features from the backbone architecture network; as well as
Detect heads that obtain the positions of one or more object bounding boxes and one or more key points from the neck network.

4. The detection method for objects and key points according to claim 3, wherein the detect heads comprise a large object detect head, a medium object detect head, and a small object detect head, which are used to obtain the positions of one or more object bounding boxes and one or more key points from multiple blocks of different sizes in the neck network, respectively.

5. The detection method for objects and key points according to claim 1, wherein the deep neural network architecture is trained based on multiple candidate samples and multiple benchmark real samples, and the threshold for determining whether the predicted box is the object bounding box corresponds to the average and square difference of the multiple candidate samples and their corresponding benchmark real samples.

6. The detection method for objects and key points according to claim 5, wherein the object box regression Distance Intersection Over Union loss function of the deep neural network architecture is related to the following two:
The threshold; as well as
The ratio of multiple intersection to union sets of multiple candidate samples and their corresponding multiple benchmark real samples.

7. The detection method for objects and key points according to claim 1, wherein the key point loss function of the deep neural network architecture is a wing loss function.

8. The detection method for objects and key points according to claim 1, wherein the deep neural network architecture evaluates the performance of object key point detection during training using one or any combination of the following algorithms:
Object key-point similarity algorithm; as well as
Percentage of correct key-points algorithm.

9. The detection method for objects and key points according to claim 1, wherein the one or more object bounding boxes and their corresponding one or more key points correspond to one or any combination of the following categories of objects: face, hand, mobile phone, cigarette, glasses, and seat belt.

10. A host for objects and key points detection, comprising one or more processors for executing multiple computer instructions stored in non-volatile memory to implement the detection method for objects and key points as claimed in claim 1.

11. A driver monitoring system for objects and key points detection, comprising:
The host as claimed in claim 10 set within the vehicle; as well as
A photography device for providing the image.
